(19) United States
(12) Patent Application Publication
(10) Pub. No.: US 2026/0358027 A1
(43) Pub. Date: Nov. 12, 2026

(54) ELASTOCALORIC COOLING DEVICE

(71) Applicant: THE HONG KONG UNIVERSITY OF SCIENCE AND TECHNOLOGY, Hong Kong (CN)

(72) Inventors: Guoan ZHOU, Hong Kong (CN); Shuhuai YAO, Hong Kong (CN); Qingping SUN, Hong Kong (CN)

(21) Appl. No.: 19/606,925

(22) PCT Filed: Dec. 25, 2024
(86) PCT No.: PCT/CN2024/142215

§ 371 Date: Jul. 16, 2026

Related U.S. Application Data
(60) Provisional application No. 63/622,036, filed on Jan. 17, 2024.

(51) Int. Cl. F25B 23/00

(52) U.S. Cl. CPC F25B 23/00

(57) ABSTRACT

The elastocaloric cooling device (10) includes a plurality of elastocaloric modules (12, 14, 16, 18, 20), where each of the elastocaloric modules (12, 14, 16, 18, 20) has at least one tube (52) embedded in a retainer (54). The at least one tube (52) is formed from a shape memory alloy. A pump (30) is in fluid communication with each of the elastocaloric modules (12, 14, 16, 18, 20) for driving a heat transfer fluid (HTF) through the at least one tube (52) of each of the elastocaloric modules (12, 14, 16, 18, 20) with a cyclic alternating direction of fluid flow. The plurality of elastocaloric modules (12, 14, 16, 18, 20) are fluidly connected in parallel such that the fluid flow of the heat transfer fluid (HTF) through the at least one tube (52) of each of the elastocaloric modules (12, 14, 16, 18, 20) is simultaneous and identical.

### CROSS-REFERENCE TO RELATED APPLICATIONS

This application claims the benefit of U.S. Provisional Patent Application No. 63/622,036, filed on Jan. 17, 2024.

### TECHNICAL FIELD

The disclosure of the present patent application relates to refrigeration, and particularly to a cooling device which makes use of the elastocaloric effect.

### BACKGROUND ART

Elastocaloric materials are a class of advanced materials which exhibit a large change in temperature when mechanical stress is applied and then removed. These materials exhibit the “elastocaloric effect,” which is the reversible thermal response of the material to mechanical loading and unloading. The elastocaloric effect is often caused by changes in entropy within the material's structure, such as through phase transformations or reorientation of crystalline domains. Due to the large temperature changes exhibited by elastocaloric materials, there is a great deal of interest in their usage for solid-state refrigeration applications.

Traditional cooling technologies, such as vapor-compression refrigeration, rely on harmful refrigerants that contribute to global warming and have significant energy consumption. In contrast, elastocaloric materials offer an environmentally friendly and energy-efficient alternative. These materials can convert mechanical energy to thermal energy, thus potentially replacing conventional systems, which will lead to reduced greenhouse gas emissions and lower energy usage.

When mechanical stress is applied to an elastocaloric material, such as through stretching, compression or bending, the material can either absorb heat from its surroundings (resulting in cooling) or release heat (resulting in heating). Shape memory alloys (SMAs) exhibit the elastocaloric effect. This effect is closely connected to the reversible phase transition between different crystal structures; e.g., the transition from austenite to martensite. During this transition, the entropy of the system changes due to the rearrangement of atoms and changes in internal energy. The transformation from a high-symmetry austenitic phase to a low-symmetry martensitic phase can either absorb or release latent heat, which depends on whether the process is endothermic or exothermic. The temperature change (ΔT) depends on several factors, including material composition; the size, distribution and orientation of grains within the material; and the type and magnitude of the applied stress. By controlling these factors, the elastocaloric effect can be finely tuned, which allows for the design of materials with tailored thermal responses for specific applications.

Elastocaloric materials are diverse and include a range of shape memory alloys, which are among the most widely studied due to their pronounced phase transition properties. Notable examples of such shape memory alloys include nickel-titanium (NiTi) Alloys, copper-based alloys (e.g., Cu-Zn-Al and Cu-Al-Ni), and iron-Based Alloys (e.g., Fe-Pd and Fe-Ni). Additionally, some polymer-based materials and ceramics exhibit elastocaloric effects due to entropy changes associated with stretching or bending. These materials can provide unique advantages, such as flexibility and lower weight. The choice of material for elastocaloric applications depends on several criteria, including the desired operating temperature range, the required mechanical strength, the material's durability under cyclic loading (fatigue resistance), and cost considerations.

Thus, an elastocaloric cooling device solving the aforementioned problems is desired.

### DISCLOSURE

The elastocaloric cooling device includes a plurality of elastocaloric modules, where each of the elastocaloric modules has at least one tube embedded in a retainer. The at least one tube is formed from a shape memory alloy. A pump is in fluid communication with each of the elastocaloric modules, such that the pump drives a heat transfer fluid through the at least one tube of each of the elastocaloric modules with a cyclic alternating direction of fluid flow. As a non-limiting example, the heat transfer fluid may be a suspension of graphene in water. The plurality of elastocaloric modules are fluidly connected in parallel such that the fluid flow of the heat transfer fluid through the at least one tube of each of the elastocaloric modules is simultaneous and identical. Although connected fluidly in parallel, the plurality of elastocaloric modules may be arranged linearly such that the elastocaloric modules are axially aligned with respect to one another.

These and other features of the present subject matter will become readily apparent upon further review of the following specification.

### BRIEF DESCRIPTION OF THE DRAWINGS

FIG. 1A is a schematic illustration of an elastocaloric cooling device operating in the first half of one operational cycle.

FIG. 1B is a schematic illustration of the elastocaloric cooling device operating in the second half of the cooling cycle.

FIG. 2 is partially exploded perspective view of an elastocaloric module of the elastocaloric cooling device.

FIG. 3 is a front view of a loading head of the elastocaloric module of FIG. 2.

FIG. 4 is a front perspective view of a tube of the elastocaloric module of FIG. 2.

FIG. 5 diagrammatically illustrates a linear or serial arrangement of the elastocaloric modules of the elastocaloric cooling device.

FIG. 6A is a plot comparing the zero-lift specific cooling power of graphene nanofluid and distilled water as the heat transfer fluid in the elastocaloric cooling device.

FIG. 6B is a plot comparing the no-load temperature lift of graphene nanofluid and distilled water as the heat transfer fluid in the elastocaloric cooling device.

FIG. 7A is a plot showing the variation of the cooling power (CP) and specific cooling power (SCP) as a function of temperature lift (T_{lift}) at different flow rates for the elastocaloric cooling device operating at a switching frequency of 3.5 Hz with an applied stress of 950 MPa

FIG. 7B is a graph showing the results of a direct measurement of the cooling power of the elastocaloric cooling device for different thermal loads, with the elastocaloric cooling device operating at a switching frequency of 3.5 Hz with an applied stress of 950 MPa.

FIG. 7C is a graph showing the envelope of the temperature lift (T_{lift}) between the hot side and the cold side of the elastocaloric cooling device.

FIG. 7D is a plot showing the variation of the coefficient of performance (COP) of the elastocaloric cooling device as a function of the specific cooling power (SCP).

FIG. 7E is a plot showing the variation of the exergy efficiency ζ as a function of the specific cooling power (SCP) for the elastocaloric cooling device operating at a switching frequency of 3.5 Hz with an applied stress of 950 MPa.

FIG. 8 is a graph showing temperature data collected for the elastocaloric cooling device used as an air conditioner for a model house.

Similar reference characters denote corresponding features consistently throughout the attached drawings.

### BEST MODE(S)

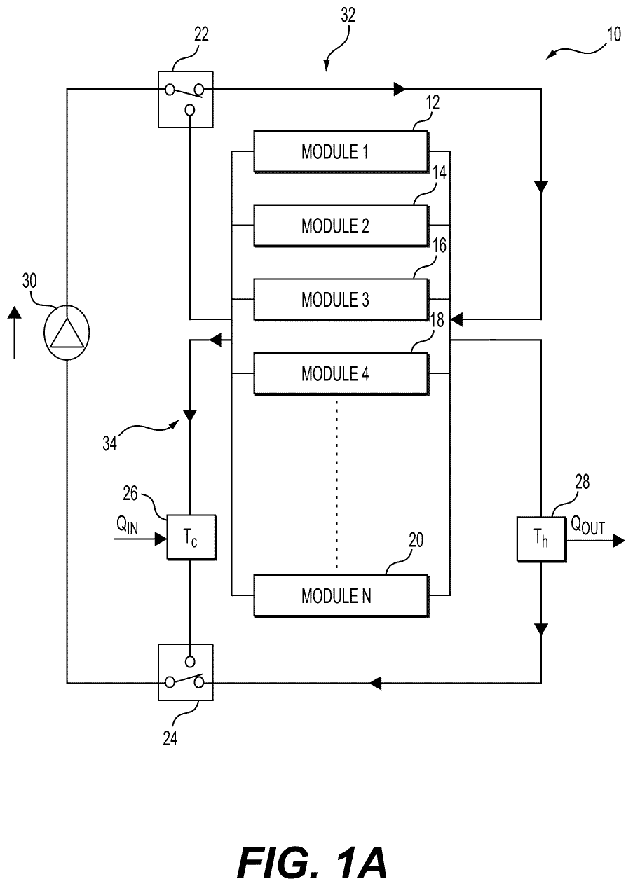

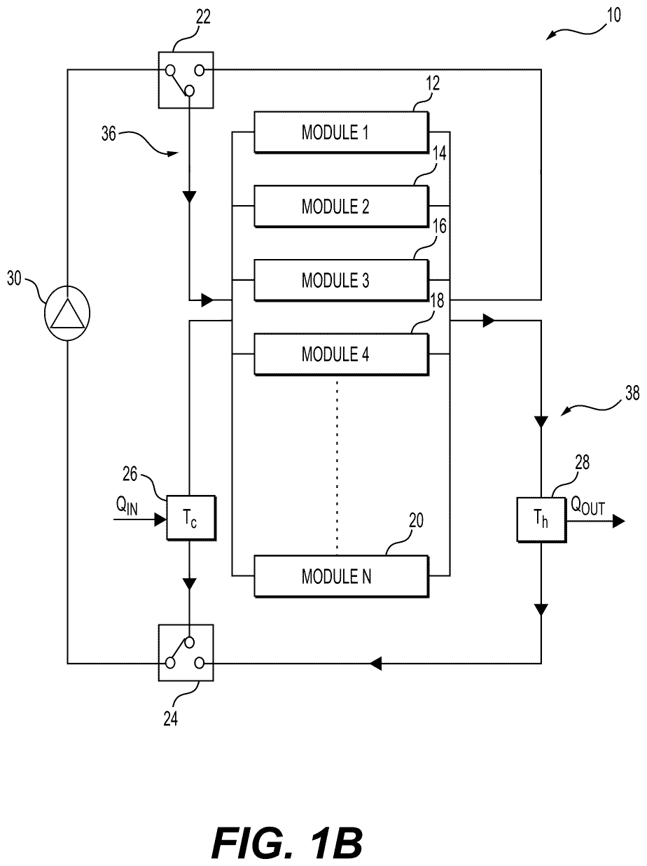

As shown in FIGS. 1A, 1B and 2, the elastocaloric cooling device 10 includes a plurality of elastocaloric modules 12, 14, 16, 18, 20, where each of the elastocaloric modules 12, 14, 16, 18, 20 has at least one tube 52 embedded in a retainer 54. The at least one tube 52 is formed from a shape memory alloy. It should be understood that any desired number of elastocaloric modules may be used and that the five elastocaloric modules 12, 14, 16, 18, 20 shown in FIGS. 1A and 1B are shown for exemplary purposes only. In FIGS. 1A and 1B, elastocaloric module 20 is labeled the N^{th} module, indicating that any desired number of elastocaloric modules may be included. As a non-limiting example, ten such elastocaloric modules may be fluidly connected in parallel.

In FIG. 2, four tubes 52 are shown embedded in retainer 54, however, it should be understood that these four tubes, and their particular geometric arrangement with respect to one another, is shown for exemplary purposes only, and that any suitable number of tubes 52 may be used within each of the elastocaloric modules. FIG. 2 illustrates only elastocaloric module 12, however, it should be understood that each of the elastocaloric modules 12, 14, 16, 18, 20 is identically constructed.

A pump 30 is in fluid communication with each of the elastocaloric modules 12, 14, 16, 18, 20, such that the pump 30 drives a heat transfer fluid (HTF) through the at least one tube 52 of each of the elastocaloric modules 12, 14, 16, 18, 20 with a cyclic alternating direction of fluid flow. The plurality of elastocaloric modules 12, 14, 16, 18, 20 are fluidly connected in parallel such that the fluid flow of the heat transfer fluid through the at least one tube 52 of each of the elastocaloric modules 12, 14, 16, 18, 20 is simultaneous and identical.

In FIG. 1A, fluid switches 22 and 24 are each in a first position, allowing the heat transfer fluid to flow through each of the elastocaloric modules 12, 14, 16, 18, 20 in a first direction, with input being through fluid path 32 and output being through fluid path 34. Fluid path 34 drives the heat transfer fluid to a first heat exchanger 26, where environmental heat is drawn into the heat transfer fluid (indicated in FIG. 1A as “Q_{IN}”), thus creating a cooling temperature effect in the environment (indicated in FIG. 1A as “T_{c}”). In FIG. 1B, fluid switches 22 and 24 are each in a second position, driving the heat transfer fluid in the opposite direction through fluid path 36, with the heat transfer fluid being output from the elastocaloric modules 12, 14, 16, 18, 20 into fluid path 38. Fluid path 38 drives the heat transfer fluid to a second heat exchanger 28, where the heated heat transfer fluid is cooled, releasing heat into the environment (indicated in FIG. 1B as “Q_{OUT}”), with the heating temperature effect on the environment being indicated in FIG. 1B as “Tₕ”.

It should be understood that any suitable type of pump or other fluid pressurizing device may be used. It should be further understood that any suitable type of switching arrangement may be used. The use of switches 22, 24 allows the pump 30 to work in a single direction, without a start-stop cycle and/or a forward-reverse cycle. Switches 22, 24 may use, as a non-limiting example, solenoid valves with a response time of approximately 15 ms, allowing for rapid changes in the fluid flow direction.

As discussed above, when mechanical stress is applied to an elastocaloric material, the material can absorb heat from the environment, resulting in cooling. The shape memory alloy (SMA) of the at least one tube 52 of each of the elastocaloric modules 12, 14, 16, 18, 20 exhibits the elastocaloric effect, thus creating an overall cooling or refrigeration effect. The mechanical stress which creates the cooling elastocaloric effect is caused by the rapid cycling of the fluid pressure (and direction) within each of the tubes 52. Although switches 22 and 24 may be switched at any suitable frequency, a non-limiting example of a cycling frequency for the fluid direction is between 0.25 Hz and 5.0 Hz.

As a non-limiting example, the heat transfer fluid may be a suspension of graphene in water. As a further non-limiting example, the graphene may have an average particle size of approximately 1 μm. The concentration of the graphene in the water may be, for example, approximately 2 g/L.

The at least one tube 52 is embedded within the retainer 54 in order to prevent buckling of the at least tube 52 due to the mechanical stress caused by the rapid cycling of the fluid pressure. As a non-limiting example, the retainer 54 may be formed of polymethylmethacrylate (PMMA). The shape memory alloy may be, as a non-limiting example, a nickel-titanium alloy. However, it should be understood that any suitable type of shape memory alloy may be used. Additional non-limiting examples of such shape memory alloys include CuZnAl alloy, NiFeGa alloy and TiNiCu alloy.

Returning to the non-limiting example of FIG. 2, four tubes 52 are shown embedded in the retainer 54. In addition to the retainer 54 and the tubes 52, the elastocaloric module 12 (as well as the identical modules 14, 16, 18, 20) may also include first and second fluid distributors 40, 60 mounted on opposed ends of the retainer 54. The first and second fluid distributors 40, 60 are in fluid communication with the pump 30 through respective ports 46, 62, and are also in fluid communication with the tubes 52. Thus, as an example, the heat transfer fluid may be driven by the pump 30 into the first fluid distributor 40, which then evenly distributes the heat transfer fluid (through openings 42, 44) into the tubes 52, and the heat transfer fluid flows from the tubes 52 into the fluid distributor 60 (through similar openings formed therethrough) for extraction through port 62. In the second half of this exemplary cycle, the direction of flow is reversed. It should be understood that any suitable type of fluid distributors may be used to distribute the fluid evenly to and from and tubes 52. As a non-limiting example, each of the fluid distributors 40, 60 may have a Y-type fluid port formed therein.

In FIG. 2, it should be understood that the central opening 42 and the circular opening 44 are shown for exemplary purposes only. In this particular example, central opening 42 is aligned with the central one of the four tubes 52, and the circular opening 44 is aligned with the other three of the four tubes 52. The number and arrangement of openings in the fluid distributors 40, 60 is dependent on the particular number and arrangement of the tubes 52 embedded in the retainer 54.

The non-limiting example of FIG. 2 also shows first and second loading heads 48, 56 respectively interposed between the retainer 54 and the first and second fluid distributors 40, 60. The first and second loading heads 48, 56 have a plurality of apertures 50, 58 respectively formed therethrough. The plurality of apertures 50, 58 are aligned with the plurality of tubes 52 such that the plurality of apertures 50, 58 are in fluid communication with the plurality of tubes 52. The plurality of apertures 50, 58 are also in fluid communication with the openings 42, 44 formed in fluid distributor 40 and the corresponding openings (not shown) formed in fluid distributor 60. It should be understood that first fluid distributor 40 and second fluid distributor 60 may be constructed identically, and that first loading head 48 and second loading head 56 may also be constructed identically.

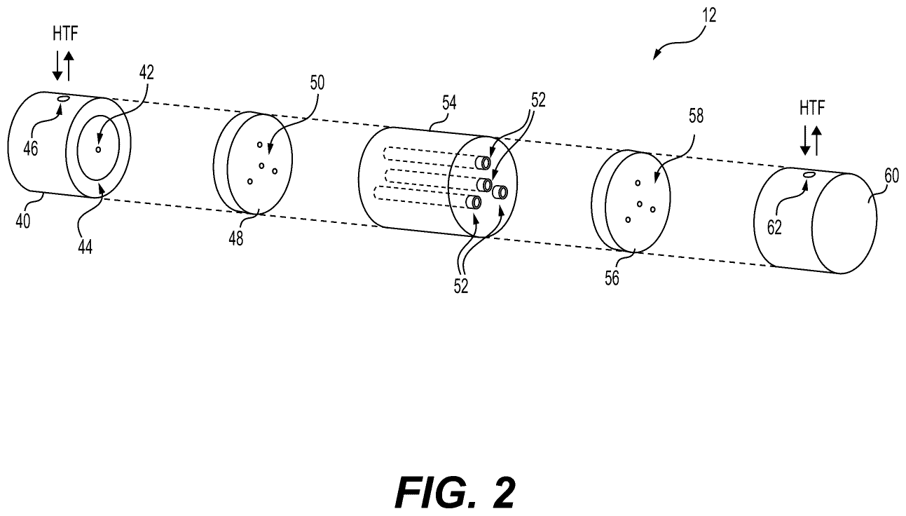

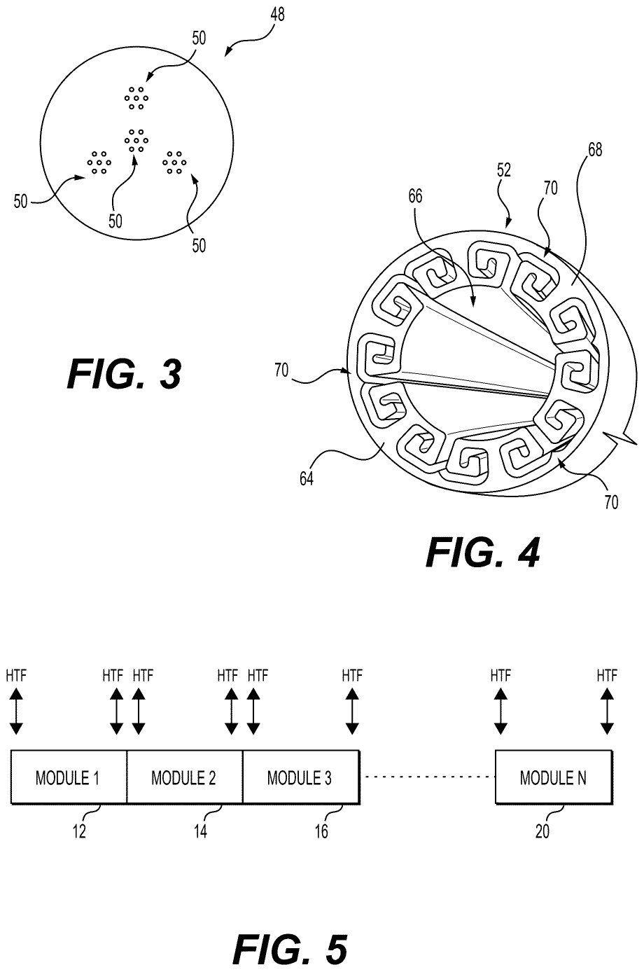

In the non-limiting example of FIG. 4, each tube 52 has a central axial channel 66 formed therethrough and also has at least one passage 70 formed within a wall 68 of the tube 52. FIG. 4 is not intended to be a cross-sectional view, rather, FIG. 4 shows one end face 64 of the tube 52. Both the central axial channel 66 and the at least one passage 70 extend continuously, in the axial direction, through the tube 52. In the non-limiting example of FIG. 4, six passages 70, each with a unique geometry, are shown, however, it should be understood that any suitable number of passages 70 with any suitable geometry may be used. As shown, each passage 70 is in fluid communication with the central axial channel 66, thus maximizing surface area for contact between the heat transfer fluid and the wall 68 of the tube 52. In the non-limiting example of FIG. 3, the apertures 50 formed through loading head 48 are shown grouped, both to align with the four exemplary tubes 52 and also such that each grouping of apertures 50 is in fluid communication with both the central axial channel 66 and the passages 70 of the corresponding tube 52.

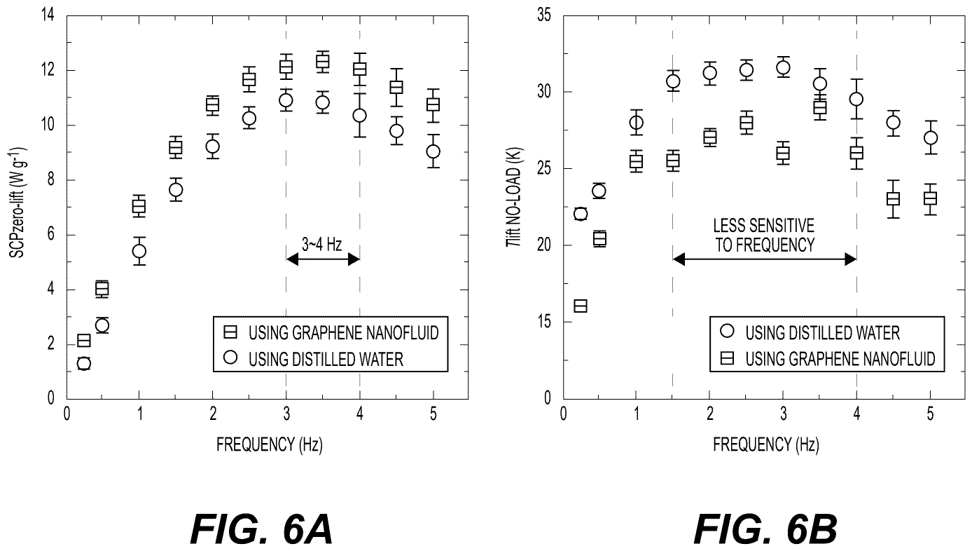

As shown in FIG. 5, although the elastocaloric modules 12, 14, 16, 18, 20 are connected fluidly in parallel, elastocaloric modules 12, 14, 16, 18, 20 may be arranged linearly such that the elastocaloric modules 12, 14, 16, 18, 20 are axially aligned with respect to one another. It should be understood that in the arrangement shown in FIG. 5, there is no axial fluid flow between the elastocaloric modules 12, 14, 16, 18, 20, rather, the fluid flow remains parallel, as shown in FIGS. 1A and 1B. The linear or “serial” arrangement of elastocaloric modules 12, 14, 16, 18, 20 of FIG. 5 provides a space-saving solution for the elastocaloric cooling device 10. It should be understood that the linear arrangement of the elastocaloric modules 12, 14, 16, 18, 20 may be supported by any suitable type of housing or support structure. As a non-limiting example, the buckling-preventing retainers 54 may be bolstered by additional guide rails.

During testing, an elastocaloric cooling device 10 was constructed with ten elastocaloric modules arranged in linear series in the axial (or force) direction, similar to the representation shown in FIG. 5, with a total of 104.4 g of NiTi SMA used evenly to construct the tubes. The heat transfer fluid was a suspension of graphene in distilled water, with an average graphene particle size of 1 μm and a concentration of graphene in the distilled water of approximately 2 g/L. Compared with plain distilled water, the graphene nanofluid exhibited an enhancement in thermal conductivity up to 50%. Contact angles of the graphene nanofluid and distilled water with NiTi measured 72.4° and 67.3°, respectively, indicating good wetting properties (θ<90°). Operating at a switching frequency of 3.5 Hz, the elastocaloric cooling device produced a specific cooling power of 12.3 W/g. A maximum cooling power of 1284.1 W was produced on the fluid side, with a no-load temperature lift of 31.6 K, endured over 2 million compressive phase-transition cycles, and maintained with a system fluid pressure below 1.5 bar during high-frequency operation.

During testing, each of the ten elastocaloric modules was constructed as illustrated in FIG. 2, including four tubes embedded in a PMMA cylindrical retainer. The cross-sectional area of the four NiTi tubes in each retainer was 32.4 mm². The tubes were constructed using the geometry illustrated in FIG. 4. Within each elastocaloric module, the specific heat transfer area of the NiTi tubes was 12.5 cm²/g. The fluid distributors and loading heads for each elastocaloric module were made from ceramic and assembled as shown in FIG. 2. For testing purposes, zirconia (ZrO₂) ceramics were used, with a relatively low thermal conductivity of 0.2 W·m⁻¹·K⁻¹. Solenoid valves were used to switching the direction of the heat transfer fluid with a response time of 15 ms.

The buckling-prevention PMMA retainers were further constrained by guide rails, allowing movement only along the axial (or force) direction. At each end of each elastocaloric module, the fluid distributors included a Y-type fluid port for connecting the SMAs with the heat transfer fluid. The completed elastocaloric cooling device used for testing had a length (in the axial direction) of about 1.5, a width of about 0.35 m, and a height of about 0.35 m.

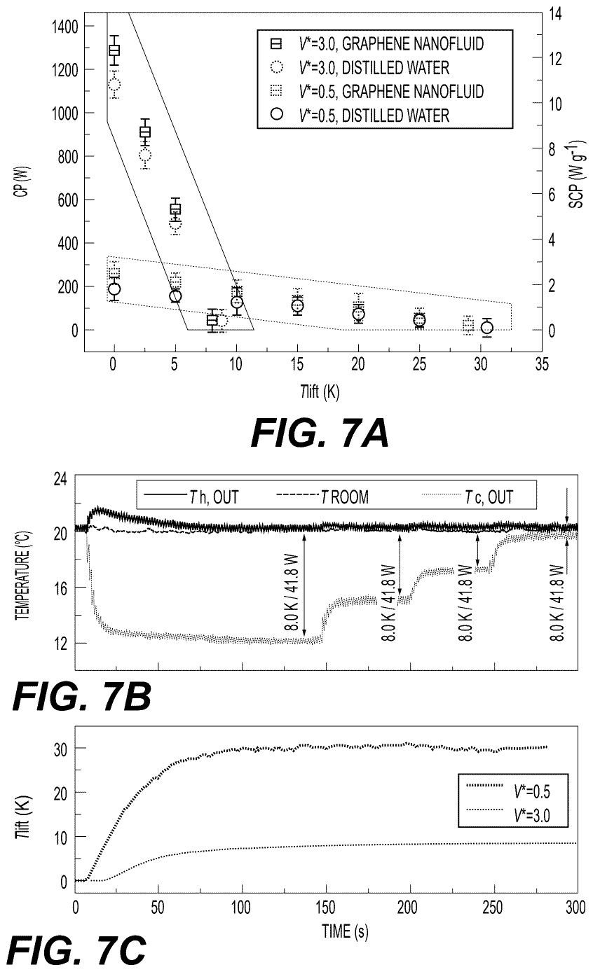

During testing, the elastocaloric cooling device was operated at eleven different frequencies: 0.25 Hz, 0.5 Hz, 1.0 Hz, 1.5 Hz, 2.0 Hz, 2.5 Hz, 3.0 Hz, 3.5 Hz, 4.0 Hz, 4.5 Hz, and 5.0 Hz. The loading and unloading times were set to be 0.05 s; e.g., when the elastocaloric cooling device was operated at 3.5 Hz, the loading-holding-unloading-holding period was 0.05 s−0.09 s−0.05 s−0.09 s. The applied stress was 950 MPa. FIG. 6A is a plot comparing the zero-lift specific cooling power (SCP_{zero-lift}) of graphene nanofluid and distilled water as the heat transfer fluid in the elastocaloric cooling device. The SCP_{zero-lift} of the device using graphene nanofluid was always larger than that using distilled water at all frequencies because of the higher heat exchange efficiency of the graphene nanofluid. The SCP_{zero-lift} using graphene nanofluids first rises and then decreases with the operating frequency and reaches a maximum value of 12.3 W/g, which corresponds to a cooling power of 1284.1 W at 3.5 Hz. The SCP _{zero-lift}using distilled water reaches its maximum value of 10.9 W/g, corresponding to a cooling power of 1138.0 W at 3.0 Hz. The trend of SCP_{zero-lift} first increasing and then decreasing with the operating frequency is due to the competition between (i) the increase in the theoretical maximum SCP of the system (i.e., (SCPₘₐₓ)_{theoretical}=Q X f, where Q is the latent heat of the elastocaloric material, f is the operating frequency), and (ii) insufficient heat exchange time when the frequency is too high; i.e., the holding time for fluid to transfer heat is too short.

FIG. 6B is a plot comparing the no-load temperature lift ((T_{lift})_{no-load}) of graphene nanofluid and distilled water as the heat transfer fluid in the elastocaloric cooling device. The (T_{lift})_{no-load} of the device also first rises and then decreases with the operating frequency whether using the distilled water or the graphene nanofluid as the HTF. However, the magnitude of the change in (T_{lift})_{no-load} (84.4%, from 16.0 K at 0.25 Hz to 29.5 K at 3.5 Hz) is smaller than the magnitude of the change in SCP_{zero-lift} (485.7%, from 2.1 W/g at 0.25 Hz to 12.3 W/g at 3.5 Hz). In other words, the (T_{lift})_{no-load} is less sensitive to the operating frequency compared with the SCP_{zero-lift}. The (T_{lift})_{no-load} of the device using graphene nanofluid as the HTF was slightly smaller than that using distilled water as the HTF at the same operating frequencies. This may be due to the small residual cooling power during the measurement of the (T_{lift})_{no-load}. In this case, the greater heat loss with the inactive parts (i.e., the loading heads, etc.) for the device using graphene nanofluid as the HTF may adversely affect the measurement of the (T_{lift})_{no-load}.

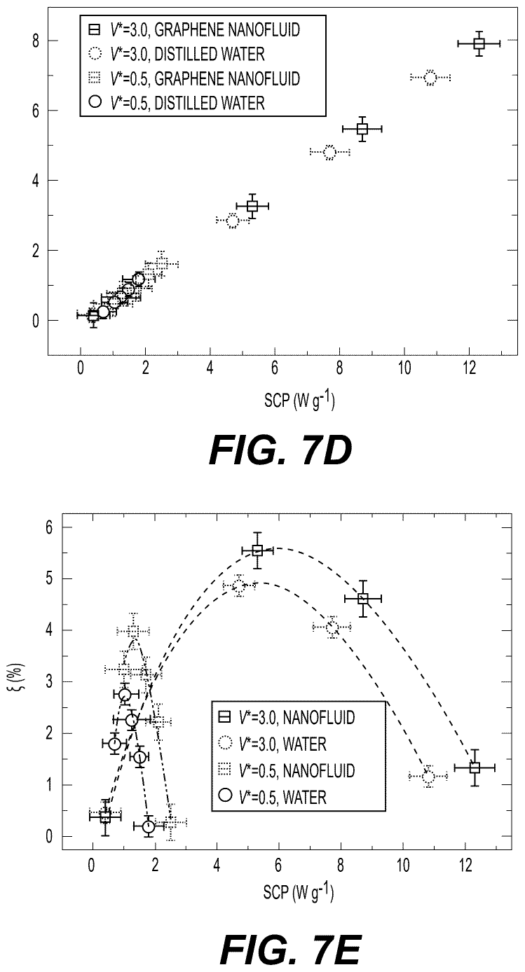

FIG. 7A is a plot showing the variation of the cooling power (CP) and specific cooling power (SCP) as a function of temperature lift (T_{lift}) at different flow rates for the elastocaloric cooling device operating at a switching frequency of 3.5 Hz with an applied stress of 950 MPa. A large flow rate of the fluids (V*=3.0) helps to achieve a large SCP, while a relatively small flow rate of the fluids (V*=0.5) helps to achieve a large (T_{lift})_{no-load}. V* represents the ratio of the fluid volume pumped through the device in a single holding period to the volume of the hollow space inside the device. The SCP_{zero-lift} of the device using graphene nanofluid as the HTF is larger than that using distilled water as the HTF until the T_{lift} exceeds 7.5 K (V*=3.0), and 28.5 K (V*=0.5).

FIG. 7B is a graph showing a direct measurement of the cooling power of the elastocaloric cooling device for different thermal loads, with the elastocaloric cooling device operating at a switching frequency of 3.5 Hz with an applied stress of 950 MPa. The same large flow rate (V*=3.0) used in FIG. 7A is also used for the data shown in FIG. 7B. The inlet fluid temperature on the hot side of SMA modules was controlled as a constant during tests through a hot-side thermal bath (HHEX). Through adjusting the inlet fluid temperature on the cold side of the SMA modules via a cold-side thermal bath (CHEX), the heating power of the merged electric resistance wire was recorded at the given temperature lifts, which equals the cooling power generated by the device at that T_{lift}. Both HHEX and CHEX were disconnected from the device for the test of maximum temperature lifts (referred to as the “no-load condition”), where the fluids were free to heat up and cool down at two ends of the device. The evolution of the no-load temperature lift of the device at different flow rates (measured with thermal-couples) is shown in FIG. 7C. Specifically, the graph of FIG. 7C shows the envelope of the temperature lift (T_{lift}) between the hot side and the cold side of the elastocaloric cooling device (operating at a switching frequency of 3.5 Hz with an applied stress of 950 MPa) until reaching steady state.

FIG. 7D is a plot showing the variation of the coefficient of performance (COP) of the elastocaloric cooling device (operating at a switching frequency of 3.5 Hz with an applied stress of 950 MPa) as a function of the specific cooling power (SCP). The data shown in FIG. 7D assumes full work recovery and does not consider the efficiency of the actuator. FIG. 7E is a plot showing the variation of the exergy efficiency ζ as a function of the specific cooling power (SCP) for the elastocaloric cooling device operating at a switching frequency of 3.5 Hz with an applied stress of 950 MPa. As shown, the COP monotonically increases with the SCP, while the exergy efficiency ζ first increases and then decreases with the SCP. This is mainly due to the energy dissipation (i.e., the mechanical energy input) changing slightly within such a small temperature lift (about 30 K), but the COP_{carnot} increases significantly when the temperature difference between Tₕ and T_{c} decreases. At the industrial standard temperature lift of 10 K (i.e., a heat sink temperature (Tₕ) of 298 K and a heat source temperature (T_{c}) of 288 K), COP and the exergy efficiency ζ of the device using graphene nanofluid as the HTF are 1.2% and 3.1%, respectively. The device using graphene nanofluid as the HTF possesses the largest COP of 7.9 when its SCP equals 12.3 W/g, and the largest exergy efficiency ζ of 5.6% when its SCP equals 5.3 W/g.

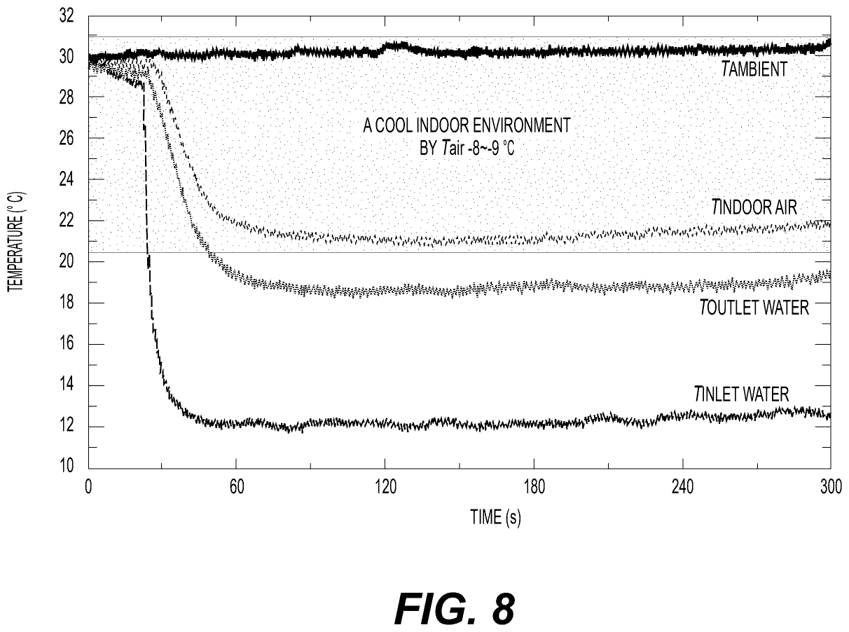

For further testing in real world conditions, a model house was constructed with a length of 1.5 m, a width of 1.0 m, and a height of 1.8 m (2.7 m³ total volume). The house was located in an outdoor space. The elastocaloric cooling device was installed to demonstrate its use as an air conditioning unit, with the elastocaloric cooling device used to chill water. The produced T_{c,out} cold water had a temperature of 12 °C and was pumped from the device to a fin radiator installed inside the model house. A steady indoor air temperature of 21-22 °C was reached within three minutes during the summer, with an outdoor temperature of 30-31 °C. FIG. 8 is a graph showing the data collected for the model house. Further experimental data can be found in the inventors' article, Zhou, Guoan, et al. “A multi-material cascade elastocaloric cooling device for large temperature lift.” Nature Energy (2024): 1-9.

It is to be understood that the elastocaloric cooling device is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An elastocaloric cooling device, comprising:
a plurality of elastocaloric modules, wherein each of the elastocaloric modules comprises at least one tube embedded in a retainer, the at least one tube comprising a shape memory alloy; and
a pump in fluid communication with each of the elastocaloric modules such that the pump drives a heat transfer fluid through the at least one tube of each of the elastocaloric modules with a cyclic alternating direction of fluid flow,
wherein the plurality of elastocaloric modules are fluidly connected in parallel such that the fluid flow of the heat transfer fluid through the at least one tube of each of the elastocaloric modules is simultaneous and identical.

2. The elastocaloric cooling device as recited in claim 1, wherein the at least one tube of each of the elastocaloric modules comprises a plurality of tubes.

3. The elastocaloric cooling device as recited in claim 2, wherein each of the elastocaloric modules further comprises first and second fluid distributors mounted on opposed ends of the retainer, the first and second fluid distributors each being in fluid communication with the pump and the plurality of tubes.

4. The elastocaloric cooling device as recited in claim 3, wherein each of the elastocaloric modules further comprises first and second loading heads respectively interposed between the retainer and the first and second fluid distributors, and wherein each of the first and second loading heads has a plurality of apertures formed therethrough, the plurality of apertures being aligned with the plurality of tubes such that the plurality of apertures are in fluid communication with the plurality of tubes.

5. The elastocaloric cooling device as recited in claim 1, wherein the at least one tube has a central axial channel formed therethrough and further has at least one passage formed within a wall of the at least one tube, the at least one passage being in fluid communication with the central axial channel.

6. The elastocaloric cooling device as recited in claim 1, wherein the plurality of elastocaloric modules are arranged linearly such that the elastocaloric modules are axially aligned with respect to one another.

7. The elastocaloric cooling device as recited in claim 1, wherein the shape memory alloy is a nickel-titanium alloy.

8. The elastocaloric cooling device as recited in claim 1, wherein the retainer comprises polymethylmethacrylate.

9. The elastocaloric cooling device as recited in claim 1, wherein the heat transfer fluid comprises a suspension of graphene in water.

10. The elastocaloric cooling device as recited in claim 9, wherein the graphene has an average particle size of 1 μm.

11. The elastocaloric cooling device as recited in claim 10, wherein a concentration of the graphene in the water is 2 g/L.
